(19) United States
(12) Patent Application Publication
(10) Pub. No.: US 2012/0188862 A1
(43) Pub. Date: Jul. 26, 2012

(54) APPARATUS AND METHOD FOR CERTIFYING A MAGNETIC RECORDING DISK

(76) Inventors: Siang Huei Leong, Singapore (SG); Ka Wei Ng, Singapore (SG); Zhimin Yuan, Singapore (SG); Bo Liu, Singapore (SG)

(21) Appl. No.: 13/499,686

(22) PCT Filed: Sep. 30, 2009
(86) PCT No.: PCT/SG2009/000361

§ 371 Date: Mar. 30, 2012

(51) Int. Cl. G11B 20/18

(52) U.S. Cl. 369/53.41; G9B/20.051

(57) ABSTRACT

Apparatuses and methods for certifying a magnetic recording disk (102) are disclosed herein, in a described embodiment, the apparatus (100) comprises a certifier head (104) for testing the disk's magnetic properties and a product head (106) for testing the disk's mechanical properties and the apparatus (100) is configured to enable simultaneous access to the disk (102) by the product head (106) and the certifier head (104). A method of upgrading a media certifier is also disclosed.

### BACKGROUND AND FIELD OF INVENTION

This invention relates to apparatus and method for certifying a magnetic recording disk.

A magnetic storage device such as a hard disk drive (HDD) typically has one or more magnetic recording disk and a read/write head for writing to and reading data from the disk. It is also normal to test the storage device at the end of the assembly process to ensure that it functions properly prior to shipping out the storage device. However, if a defect is detected during such test and the cause is due to an internal component, such as the disk, the storage device needs to be disassembled to rectify the defect and this result in costly rework.

Thus, it is normal for the disk to be tested and certified prior to it being assembled into the storage device. However, current techniques of testing and certifying the disk need improvement.

It is an object of this invention to provide apparatus and method for certifying a magnetic recording disk which address at least one of the disadvantages of the prior art and/or to provide the public with a useful choice.

### SUMMARY OF THE INVENTION

In a first specific expression of the invention, there is provided apparatus for certifying a magnetic recording disk, the apparatus comprising:

a certifier head for testing the disk's magnetic properties;

a product head for testing the disk's mechanical properties, the apparatus being configured to enable simultaneous access to the disk by the product head and the certifier head.

In a second specific expression of the invention, there is provided a method of certifying a magnetic recording disk, the method comprising:

providing a certifier head for testing the disk's magnetic properties; providing a product head for testing the disk's mechanical properties, and simultaneously accessing the disk by the product head and the certifier head.

The certifier head writer is preferably configured to write wider tracks than the product head's writer head to achieve a higher test throughput.

As it can be appreciated, the described embodiment provides concurrent multifold measurements over a conventional certifier head test, and the ability to decouple the measured parameters so as to offer distinct measurement for each type of test and is able to qualify the disk suitable for real HDD operation instead of just certifier pass standard.

The certifier head and the product head may be configured to measure the same track of the disk. Preferably, the testing or measurement performed by the certifier and the product head are carried out concurrently. The certifier head may be configured to fly at a higher flying height to the disk than the product head. The certifier head may be configured to lag the product head by 180°.

Advantageously, the certifier head and the product head are configured to read an unique identification on the disk, and the apparatus is configured to compare a magnetic image or line profile of the corresponding read back unique identification to determine the phase delay between the certifier head and the product head.

Preferably, the certifier head and the product head are configured to read back signals from a track of the disk, the apparatus being configured to compare respective read-back signals from the certifier head and the product head to determine degree of micro-waviness of the disk or degree of flying height modulation. Depending on the test, the certifier head may write to the track of the disk which is to be read back by the certifier head and the product head. The apparatus may be configured to calculate a difference from the comparison and compare the difference with a threshold to certify the disk.

The certifier head may be configured to perform measurement of the disk's magnetic properties and the product head is configured to perform mechanical measurement of the disk's mechanical properties, the apparatus being configured to isolate magnetic induced information from the product head's measurement based on the certifier head's measurement.

The measurement of the disk's magnetic properties may include missing pulse or readback envelope amplitude measurement and the measurement of the disk's mechanical properties may include in-situ flying height measurement, and the apparatus may be configured to normalise intensities of the missing pulse or readback envelope amplitude and the flying height measurements and to subtract one of the measurements from the other to isolate the magnetic induced information.

Based on the realisation of the present invention, it is also envisaged that other criteria may be used to certify a disk where a certifier head and a product head are configured to access a disk simultaneously or separately, for example at two different test stations. These aspects thus form further specific expressions of the present invention.

According to a third specific expression, there is provided a method of certifying a disk based on degree of micro-waviness of the disk or flying height modulation, the disk having a track pattern written by a certifier head, the method comprising, a product head, reading the track pattern to obtain a first read-back signal; and comparing the first read-back signal and a second read-back signal, the second read-back signal being a signal obtained by the certifier head reading the track pattern to determine the degree of micro-waviness of the disk or flying height modulation for certifying the disk.

According to a fourth specific expression, there is provided apparatus for certifying a disk based on degree of micro-waviness of the disk or flying height modulation, the disk having a track pattern written by a certifier head, the apparatus comprising: a product head configured to read the track pattern to obtain a first read-back signal; and a processor configured to compare the first read-back signal and a second read-back signal, the second read-back signal being a signal obtained by the certifier head reading the track pattern, to determine the degree of micro-waviness of the disk or flying height modulation for certifying the disk.

Preferably, a difference is calculated from the comparison and the difference is compared with a threshold to certify the disk. Preferably, the certifier head and the product head access the disk simultaneously.

According to a fifth specific expression of the invention, there is provided a method of certifying a disk having a track pattern written by a certifier head, the method comprising a product head, reading the track pattern to measure the disk's mechanical properties; and isolating magnetic induced information from the product head's measurement based on the certifier head's measurement of the disk's magnetic properties.

According to a sixth specific expression of the invention, there is provided apparatus for certifying a disk having a track pattern written by a certifier head, the apparatus comprising:

a product head configured to read the track pattern to measure the disk's mechanical properties; and

a processor for isolating magnetic induced information from the product head's measurement based on the certifier head's measurement of the disk's magnetic properties.

Specifically, the measurement of the disk's magnetic properties may include missing pulse measurement or readback envelope amplitude and the measurement of the disk's mechanical properties may include in-situ flying height measurement, and the method may further comprise normalising intensities of the missing pulse or readback envelope amplitude and the flying height measurements and subtracting one of the measurements from the other to isolate the magnetic induced information. Preferably, the certifier head and the product head access the disk simultaneously.

### BRIEF DESCRIPTION OF THE DRAWINGS

An embodiment of the invention will now be described, by way of example, with reference to the accompanying drawings in which,

FIG. 1 is a schematic diagram of an apparatus comprising a certifier head and product head for certifying a magnetic recording disk according to an embodiment of this invention;

FIG. 2 is a cross-sectional magnified view of part of the disk and part of the product head of FIG. 1;

FIG. 3 is a simplified view of the apparatus of FIG. 1 to illustrate a calibration procedure based on an identification on the disk;

FIG. 4 are graphs showing the effects of microwaviness on the flyability of the product head of FIG. 1 as the flying height is reduced; FIG. 5a is a graph showing flying height (FH) signal of a disk with good lube conditions whereas FIG. 5b is a graph showing FH signals of a disk with poor lube conditions; and

FIG. 6a shows a read-back magnetic field image of an in-situ flying height measurement from the product head of FIG. 1, FIG. 6b shows a read-back magnetic field image of a missing pulse measurement from the certifier head of FIG. 1; and FIG. 6c is an image obtained by processing the images of FIGS. 6a and 6b.

### DETAILED DESCRIPTION OF PREFERRED EMBODIMENT

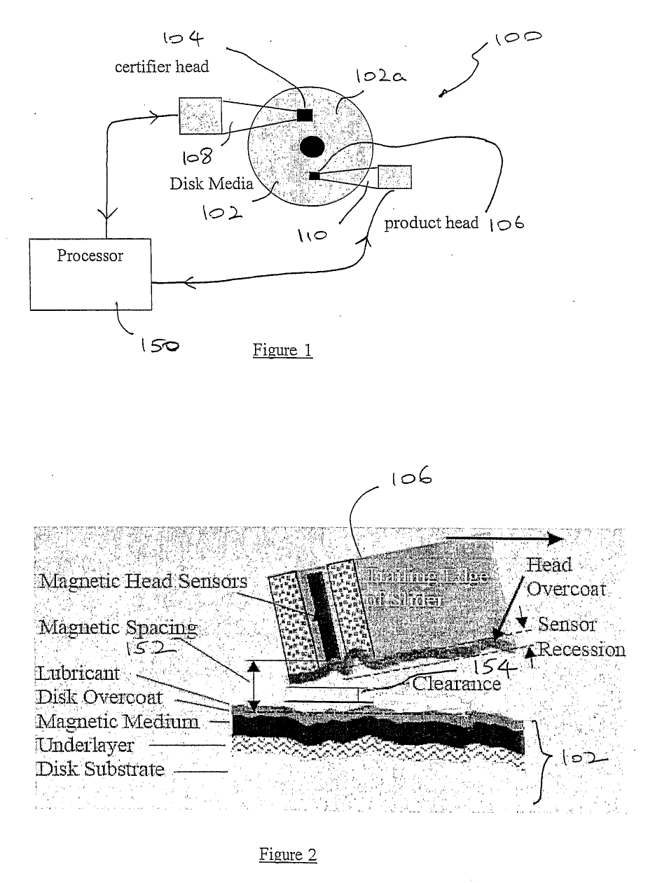

FIG. 1 is a schematic diagram of the apparatus 100 for certifying a magnetic recording disk or medium 102, such as that used in a hard disk drive (HDD), according to a preferred embodiment of the present invention. The magnetic recording disk 102 is arranged to spin by a motor (not shown) at a predetermined speed based on test conditions. The apparatus 100 comprises a certifier head 104 for testing magnetic properties of the magnetic recording disk 102 and a product head 106 for testing mechanical properties of the magnetic recording media 102. The certifier head 104 is mounted to a slider supported by a first actuator arm 108 for moving the certifier head to its destination. Similarly, the product head 106 is mounted to a slider supported by a second actuator arm 110. Both the certifier head 104 and the product head 106 are configured to simultaneously access the same surface 102a of the magnetic recording disk 102. The apparatus 100 also includes a processor 150 for processing the signals or measurements from the certifier and/or product heads 104,106.

The magnetic properties measured by the certified head 104 include Glide, Acoustic Emission (AE) [3], or Missing-Extra Pulse (MEP) [1]. In this embodiment, the certifier head 104 is a conventional certifier head used in a media certifier and differs from the product head 106 in that while its read head (or reader) is of the same size as that of the product head, however, for purposes of increasing test throughput, the certifier head 104 possesses a wider write head (or writer) to write tracks which are much wider than the area sensed by its reader. It is envisaged that more than one certifier head may be used for speeding up the certification process, by dividing different regions of the disk to different certifier heads for concurrent inspection. Indeed, it is envisaged that there can be two or more certifier heads and/or product heads concurrently accessing the disk 102.

To test the magnetic properties of the disk effectively, the slider of the certifier head 104 is of micro or nano structure and is arranged to fly higher (˜25 nm or more) compared to the product head 106 which files at sub-10 nm flying height. However, at the higher flying height, it is difficult to detect or measure mechanical flyability problems [4,5,6] such as waviness/flatness, disk roughness [4,5,6] and lubricant transfer associated with the disk media. FIG. 2 is a cross-sectional magnified view of part of the disk 102 and part of the product head 106 to illustrate the relationship between flyability and the disk 102. It should be appreciated that the performance of the flying product head 106 is dependent on roughness/flatness, lubricant, clearance and intermolecular force interaction at a magnetic spacing 152 between the product head 106 and the surface of the disk 102.

If the mechanical flyability problems are left undetected, the disk may pass certification and used in a HDD, and tests performed at the HDD level may detect such failures leading to rejects and/or high cost of rework. If the HDD level tests do not sieve out such failures, the interactions or intermolecular forces could threaten stability of a product head in the HDD which may cause head-disk contact or head crashes. The problem is exacerbated with HDD products having flying height of 5nm or below. Referring again to FIG. 2, with higher recording densities, this leads to near-contact recording where the Take Off Clearance (TOC) 154 may be effectively zero. Under such circumstances, flyability issues are very critical and it is advantageous to take into account the flyability issues when certifying the disk media 102. Thus, it is important to be able to detect such problems at the disk media level testing, and this is where the product head 106 of the present embodiment is useful.

The product head 106 is arranged to fly lower than the certifier head 104 to mirror actual operating conditions of a read/write head in a HDD assembly. Indeed, the product head 106 in this embodiment is basically the same as a read/write head used in the HDD assembly so that the disk 102 may be tested as if it is assembled in the HDD.

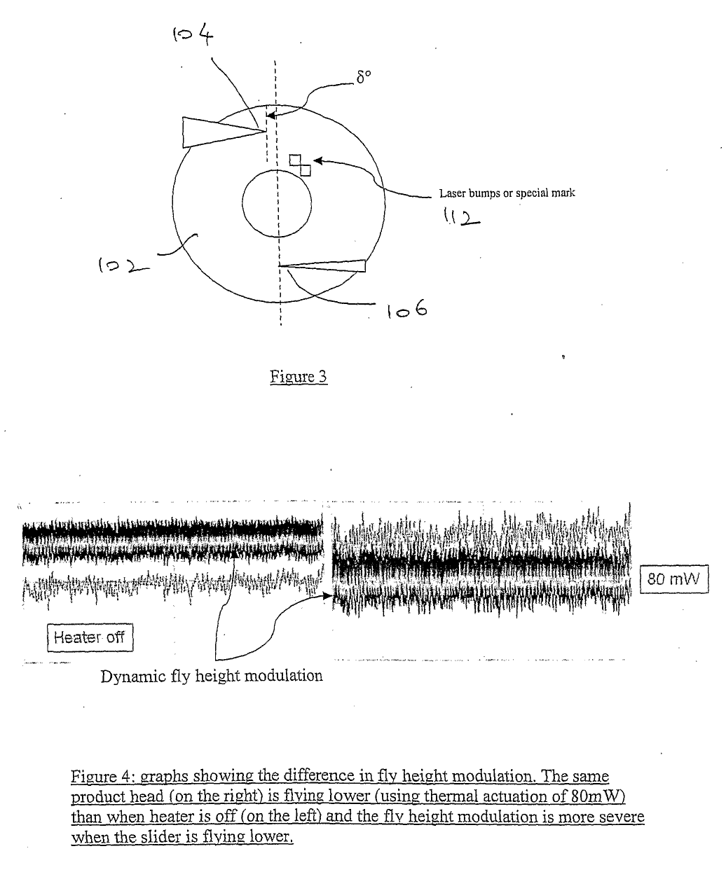

To use both heads for the certification process, the first step is to calibrate the heads 104,106 to enable reading/writing to the same track. The disk 102 under test includes an identification or marking 112 (for example, laser bump or some other suitable unique indication or pattern) at an inner diameter (ID) region of the disk media 102, as shown in FIG. 3. This marking 112 causes a change in the magnetic readback signal from the certifier head 104 and product head 106 to produce respective magnetic images or line profiles.

Both the certifier head 104 and the product head 106 are mounted on precision X-Y stages as shown in simplified form in FIG. 3. This allows exact location of one head 104,106 to be adjusted with respect to the other 104,106, ensuring that both heads 104,106 can measure the same location. The certifier head 104 preferably should be exactly 180° phase delay from the product head 106 to ensure zero skew. To achieve this, the certifier and product heads 104,106 read the marking 112 and the processor 150 compares the magnetic images or line profiles of the read-back markings and with knowledge of linear spinning velocity of the disk 102 and corresponding time delay between the certifier head and product head, the processor 150 is able to determine the phase delay, δ, in downtrack direction. The time delay refers to the time between one head (e.g. certifier head) reaching a test location and the other head (e.g. product head) reaching the same test location. The identification 112 may be used as the test location and with the delay known for a certain linear velocity, it is possible to correlate measurements from the two heads to the same testing location.

In the example of FIG. 3, the initial location of the certifier head is 180°-δ° from the product head. The product head 106 has zero skew (perfectly in downtrack direction). For the certifier head to measure the same track, based on the comparisons by the processor 150, the certifier head 104 is moved forward (to the right in FIG. 3) to eliminate phase δ and achieve zero skew position. In this way, both the certifier head 104 and the product head 106 are calibrated to measure the same track and at same skew conditions.

When calibration is completed, the certifier head 104 and product head 106 are ready to measure the magnetic and mechanical properties of the disk media 102 respectively. It would be appreciated that this arrangement brings about unprecedented advantageous of allowing other new types of measurements to be used to certify the disk media 102 and also enables measurement of conventional parameters with better accuracy.

The new types of measurements which may be used to certify the disk 102 are:
(i) in-situ flying height/clearance [4, 5]
(ii) microwaviness and influence on slider flying [6]
(iii) lube effect and influence on slider flying (Note: results in FIG. 5a, 5b)

The additional new measurements will now be described:

Such a measurement using the apparatus of FIG. 1 may be used for evaluating surface micro-waviness of the disk 102 and lubricant interaction effect on flying performance when the media 102 is assembled in a HDD.

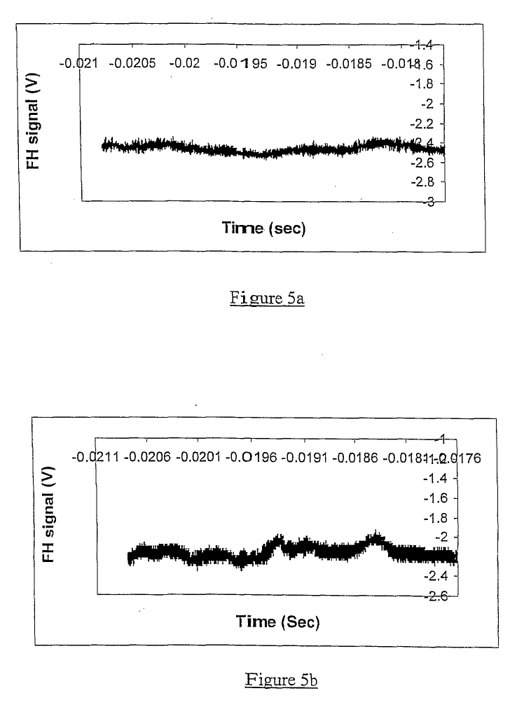

As explained earlier, the certifier head 104 flies higher than the product head 106. It is therefore subjected to less interaction with surface microwaviness or lubricant interaction compared to the product head 106 and is more stable. The product head 106 is configured to fly over the media at a flying height which mirrors that of an actual product head in a HDD and thus, product head 106 is more susceptible to the microwaviness in the form of flying height modulations of the media. If the product head 106 (or its slider) is unable to completely follow the microwaviness (i.e. the micro-modulations of the media), especially when the flying height is further reduced for ultra high density recording, this could affect the stability of the product head 106. For example, compare the graphs of FIG. 4 which illustrate that the inability to follow microwaviness increases and flying height modulations become exacerbated when flying height is further reduced.

With unstable flying of the slider or product head 106, this may cause vibrations or jitter both in cross track and down track direction. The same flying height modulations (measured by in-situ flying height approach) can be used to evaluate disks (during certification process) for their microwaviness and effects on fly stability.

One direct consequence of using both the certifier head 104 and the product head 106 for this kind of evaluation is that using the certifier head 104 as a reference to obtain a stable magnetic read back signal (as explained above, the certifier head 104 flies higher and thus is more stable), the product head 106 is used to evaluate the surface condition of the disk and assess the degree of disk microwaviness and subsequent adverse effects to an actual product head flying in a HDD. In essence, for a good disk and compatible disk/product head combination in a HDD, the product head is able to fly stably. Through the measurement of the degree of microwaviness, it is possible to obtain the degree of the product head flying height modulations and if it is beyond a threshold, then the disk 102 under test should be rejected as it is highly likely to cause problems in an actual HDD which uses a product head flying at substantially the same height.

One way to generate a threshold is to use flying height simulation results based on slider designs for both the certifier and product heads. The same simulation can provide calculated values of flying height modulations in response to disks of certain characteristics including flatness, flutter and microwaviness. Alternatively, one can use other test information such as Acoustic Emission signal during touch down and take off process to determine regime of intermittent disk contact and find the maximum allowable amplitude of fly modulations before near contact occurs as the threshold.

In this embodiment, it is proposed to perform the same flying height measurement by the certifier head 104 and product head 106 and the results compared. The certifier head 104 is arranged to provide flying height information that is a by-product when it is certifying the disk 102, for example during missing extra pulse or amplitude measurement. During such a measurement, the certifier head 104 is configured to write all 1's pattern and the same readback waveform from all 1's pattern can be processed by the processor 150 for flying height calculation based on the measurement by the certifier head 104. Background information on flying height measurement may be understood from references [4,5].

Next, the product head 106 is configured to read the all 1's pattern written by the certifier head 104. It should be appreciated that the l′s pattern is much wider than the width of the read head of the product head 106. The read back waveform from the product head 106 is similarly processed by the processor 150 for flying height calculation.

The processor 150 then compares the flying height calculations measured by the certifier head 104 and the product head 106 to obtain a difference. If the flying height modulations (i.e. the difference) thus obtained is greater than the threshold, this suggests possible severe fly modulations caused by poor lube or surface conditions on the disk 102 and thus, the disk 102 should be rejected. If the difference is less than the threshold, the disk 102 would be certified to pass, at least based on flying height.

It should be appreciated that certifying a disk based on flying height modulations offers a new way of passing or rejecting a disk. It should also be appreciated that the disks under certification do not have servo information and thus, it is not possible to conveniently use a product head to perform flying height measurement. The present embodiment solves this by using the pattern written by the certifier head 104 for the product head 106 to keep on track since the written pattern is wider than the read head of the product head 106. In this way, the product head 106 is able to fly within the region of the track and reduce the risk of going off-track caused by vibration or thermal drift.

Another advantage of the “two head configuration” shown in FIG. 1 is that the certifier head 104 may write wide tracks of a special pattern required for concurrent in-situ flying height measurement by both the certifier writer head 104 and the product head 106. This eliminates the need to use the certifier head first (to write the required pattern for in-situ measurement) followed by replacing the certifier head 104 by the product head 106 for actual in-situ measurements (the required pattern cannot be written by the product head as its writer cannot write wide enough to eliminate off-track possibility during actual in-situ measurement), resulting in significant time savings.

As mentioned earlier, by having the certifier head 104 and the product head 106 accessing the media 102 concurrently or simultaneously, this allows measurement of conventional parameters with better accuracy, as can be appreciated below.

Isolating Data from Product Head

By having the certifier head 104 and the product head 106 accessing the disk 102 concurrently or simultaneously, the certifier head 104 and the product head 106 cooperate to provide measurements which may be combined or compared to achieve synergistic results, over and beyond what is possible in current certification process. For example, using such an arrangement, it is possible to isolate noise caused by cross talk from parameters other than the one that is measured. By using two heads of a different nature, it is more likely to be able to decouple information and extract required data.

In conventional media certification with a single head it is not easy to decouple magnetic defects from other non-magnetic originated lube or physical microscale surface effects, since the latter can cause flying instability leading to change in head-disk spacing and subsequent changes in magnetic readback signal. Thus, it is of great advantage to be able to isolate effects of magnetic and non-magnetic origin.

To address the above, it is envisaged that the certifier head 104 and the product head 106 are structurally and functionally different and thus, they are not affected by the same conditions. For example, a certifier head flies higher than the product head 106 and is unlikely to be affected by the same conditions. To elaborate further, FIG. 5a is a graph showing flying height (FH) signal of a disk media with good lube conditions whereas FIG. 5b is a graph showing FH signals of a disk with poor lube conditions. Depending on the flying height of the certifier head 104, it may not be affected by the disk which exhibits the poor lube conditions of FIG. 5b but this may be detected by the product head 106. Based on these differences, it is envisaged that more accurate measurements may be performed and this will be elaborated further below.

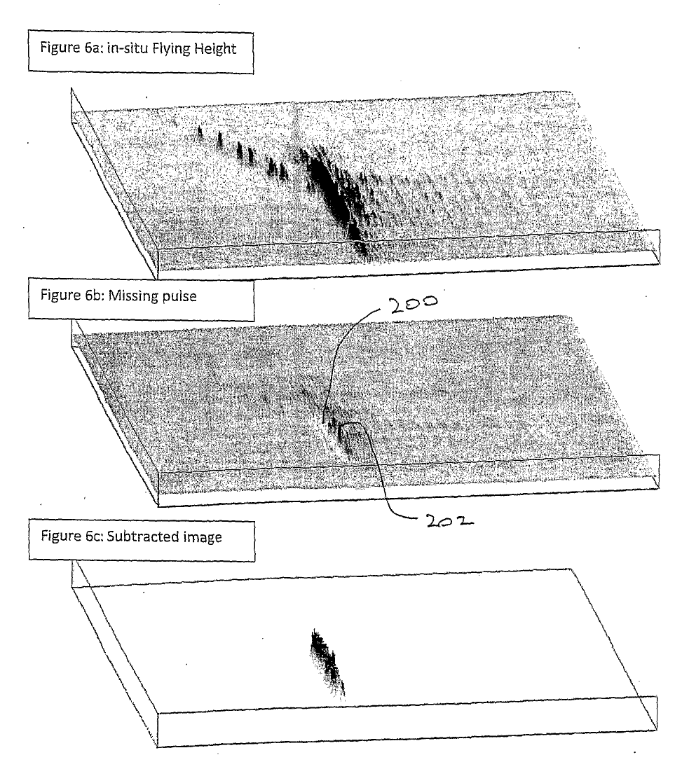

FIG. 6a shows a read-back magnetic field image of an in-situ flying height measurement from the product head 106 and FIG. 6b shows a read-back magnetic field image of a missing pulse measurement from the certifier head 104. The product head 106 uses harmonic ratio to obtain the in-situ flying height measurement which is more resilient to magnetic signal intensity changes, as compared to the missing pulse measurement which is affected by both spacing changes and magnetic defects.

FIG. 6c is an image obtained by processing the images of FIGS. 6a and 6b and in this embodiment, this is performed by normalizing the intensity range of images in FIGS. 6a and 6b, and setting the background intensities (of the normalized images) of both measurements until they are the same and then perform a subtraction and in this embodiment the flying height signal of FIG. 6a is used to minus the magnetic signal of FIG. 6b (although the reverse can also be done, i.e. image of FIG. 6b minus image of FIG. 6a). The resultant contrast from the subtraction is what is important since this represents the isolated defect information. To elaborate, the image of FIG. 6a represents a flying height signal as measured by in-situ flying height measurement, and FIG. 6b is the missing pulse measurement as explained earlier. As mentioned earlier, these measurements may be obtained at the same time as processing the readback of the all 1s pattern. If the product head 106 flies higher due to surface interaction with lube, particles or surface defects etc on the surface 102a of the disk 102, the magnetic signal drops (as represented by white region 200 in FIG. 6b—depression or lowest signal is represented by the white region, whereas the protrusion or largest signal is represented by black region 202). Dropout of reduced magnetic signal can be due to either local defects at magnetic disk 102 or caused by change in flying height from other causes. However the in-situ flying height signal is less affected by magnetic signal dropout, and it correctly indicates increased flying height (darker contrast in FIG. 6a represents increased flying height caused by some surface interaction). Thus, by subtracting magnetic signal image from flying height signal image (or vice versa), the flying height change element common to both measurements are reduced or eliminated, leaving behind signal mainly attributed to magnetic changes (in this case dropouts) only. In this way, one can isolate magnetic defect information from spacing induced changes.

The above is opposed to conventional certification where the use of the certifier head only does not differentiate magnetic defect information from any spacing change, nor does it measure flying height modulations which may be experienced by a product head in final HDD implementation.

Instead of using subtraction, other more elaborate schemes may be utilized. Further, instead of missing pulse measurement, readback amplitude envelope measurement may be used.

Based on the above, it can be appreciated that the described embodiment uses a combination of certifier head and low flying height product head for disk certification. The combined use enables certification of disks to conditions closer to real HDD operation which is able to filter out some of the problems in ultra-low flying height configurations. Instead of relying solely on conventional certifier tests, normally untested issues, for example flying height, head-disk interface, waviness/flatness and lubricant conditions, that are becoming increasingly important to advanced HDD products featuring ultra low flying height, can be addressed by the described embodiment. Although conventional flying height measurements may be conducted in the final assembly of the HDD such as during servo writing or product read/write test, it is proposed to filter out the disks induced problems during the media or disk certification process so as to reduce rejection associated to media problems arising from anomalies in lubricant, carbon, particles etc. With the described embodiment, it is also possible to measure magnetic and fly-height clearance concurrently thus improving the productivity of certifying disks.

The described embodiment should not be construed as limitative. For example, in the described embodiment, the certifier and product heads 104,106 accessed the same track for measurement/testing. However, this may not be necessary and the heads 104,106 may test different tracks. In such a case, calibration of the heads 104,106 may not be necessary. It is typical for the certifier head 104 to have a wider write head than the write head of the product head to improve test throughput but this may not be always the case and depends on application. It is preferred for the certifier head and the product head to read/test/measure the track under testing simultaneously or concurrently but it is also envisaged that one head performs the testing first followed by the other head. For example, the certifier head 104 may perform the magnetic certification and when the magnetic properties of the disk are known, then the mechanical flyability testing by the product head 106 is carried out.

In the described embodiment, the identification or marking 112 is provided at the ID of the disk 102. This may not be necessary and the identification 112 may be provided or created at other locations of the disk 102, for example at the OD (outer diameter).

As a variation, it is envisaged that the microwaviness or the flying height measurements may be performed by the certifier head 104 and product head 106 at separate test stations, which means that both heads 104,106 do not access the surface 102a of the disk 102 concurrently or simultaneously. Likewise, the isolation of data from product head may be used for certifying the disk 102 by the certifier head 104 and the product head 106 at separate test stations where one head measures the disk 102 and then the next head.

It is also envisaged that current media certifiers may be upgraded to perform the present invention. For example, since the current media certifiers would come with a certifier head, it is proposed to upgrade the media certifiers by installing a product head so that both heads may simultaneously access the disk.

Having now fully described the invention, it should be apparent to one of ordinary skill in the art that many modifications can be made hereto without departing from the scope as claimed.

### REFERENCES

[1] Magnetic Recording Solutions webpage: http://www.mrs-usa.com/products media certifiers.html.

[2] Agrawal et al., U.S. Pat. No. 7,164,557 B2, Apparatus for burnishing small asperities and cleaning loose particles from magnetic recording media, 2007.

[3] Chu, Norman et al., U.S. Pat. No. 7,121,133, System, method, and apparatus for glide head calibration with enhanced PZT channel for very low qualification glide heights.

[4] B. Liu and Z.-M. Yuan, In-situ characterization of head disk clearance, Proc. ASME/Tribology Symp. on Interface Tribology Toward 100 Gb/in and Beyond, Seattle, Wash., pp. 51-58, 2001.

[5] Z.-M. Yuan, B. Liu, W. Zhang, and S. Hu, Engineering study of triple harmonic method for in-situ characterization of head-disk spacing, J. Magn. Magn. Mater., vol. 239, pp. 367-370, 2002.

[6] Zhi-Min Yuan, Siang Huei Leong, Sumitro Joyo Taslim, Ka Wei Ng and Bo Liu, Sub-mm disk waviness characteristics and slider flying dynamics under thermal FH control, J. Magn. Magn. Mater., vol. 320, 3189, 2008

1. Apparatus for certifying a magnetic recording disk, the apparatus comprising:
a certifier head for testing the disk's magnetic properties;
a product head for testing the disk's mechanical properties, the apparatus being configured to enable simultaneous access to the disk by the product head and the certifier head.

2. Apparatus according to claim 1, wherein the certifier head and the product head are configured to measure the same track of the disk.

3. Apparatus according to claim 1 or 2, wherein the testings by the certifier head and the product head are carried out concurrently.

4. Apparatus according to any preceding claim, wherein the certifier head is configured to fly at a higher flying height to the disk than the product head.

5. Apparatus according to any preceding claim, wherein the certifier head is configured to lag the product head by 180°.

6. Apparatus according to any preceding claim, wherein the certifier head and the product head are configured to read an unique identification on the disk, the apparatus being configured to compare a magnetic image or line profile of the corresponding read back unique identification to determine the phase delay between the certifier head and the product head.

7. Apparatus according to any preceding claim, wherein the certifier head and the product head are configured to read back signals from a track of the disk, the apparatus being configured to compare respective read-back signals from the certifier head and the product head to determine degree of micro-waviness of the disk or degree of flying height modulation.

8. Apparatus according to claim 7, wherein the certifier head is configured to write to the track of the disk which is to be read back by the certifier head and the product head.

9. Apparatus according to claim 8, wherein the apparatus is configured to calculate a difference from the comparison and compare the difference with a threshold to certify the disk.

10. Apparatus according to any preceding claim, wherein the certifier head is configured to perform measurement of the disk's magnetic properties and the product head is configured to perform mechanical measurement of the disk's mechanical properties, the apparatus being configured to isolate magnetic induced information from the product head's measurement based on the certifier head's measurement.

11. Apparatus according to claim 10, wherein the measurement of the disk's magnetic properties include missing pulse measurement or readback envelope amplitude and the measurement of the disk's mechanical properties include in-situ flying height measurement, and the apparatus is configured to normalise intensities of the missing pulse or readback envelope amplitude and the flying height measurements and to subtract one of the measurements from the other to isolate the magnetic induced information.

12. Apparatus according to any preceding claim, wherein the certifier head's write head is configured to write wider tracks on the disk than the product head's write head.

13. A method of certifying a magnetic recording disk, the method comprising: providing a certifier head for testing the disk's magnetic properties; providing a product head for testing the disk's mechanical properties, and simultaneously accessing the disk by the product head and the certifier head.

14. A method according to claim 13, further comprising measuring the same track of the disk by the certifier head and the product head.

15. A method according to claim 13 or 14, wherein the testings by the certifier head and the product head are carried out concurrently.

16. A method according to any of claims 13 to 15, further comprising flying the certifier head at a higher flying height to the disk than the product head.

17. A method according to any of claims 13 to 16, further comprising configuring the certifier head to lag the product head by 180°.

18. A method according to any of claims 13 to 17, further comprising reading an unique identification on the disk by the certifier head and the product head, comparing a magnetic image or line profile of the corresponding read back unique identification to determine the phase delay between the certifier head and the product head.

19. A method according to any of claims 13 to 18, further comprising reading signals from a track of the disk by the certifier head and the product head; comparing the respective read-back signals to determine degree of micro-waviness of the disk or degree of flying height modulation.

20. A method according to claim 19, further comprising, the certifier head, writing to a track of the disk and, the product head and the certifier head, reading said track.

21. A method according to claim 20, further comprising calculating a difference from the comparison and comparing the difference with a threshold to certify the disk.

22. A method according to any of claims 13 to 21, further comprising, the certifier head, measuring the disk's magnetic properties; the product head, performing mechanical measurement of the disk's mechanical properties, and isolating magnetic induced information from the product head's measurement based on the certifier head's measurement.

23. A method according to claim 22, wherein the measurement of the disk's magnetic properties include missing pulse measurement or readback envelope amplitude and the measurement of the disk's mechanical properties include in-situ flying height measurement, and the method further comprises normalising intensities of the missing pulse or readback envelope amplitude and the flying height measurements and subtracting one of the measurements from the other to isolate the magnetic induced information.

24. A method of upgrading a media certifier having a certifier head for testing a disk's magnetic properties, the method comprising the steps of installing a product head for testing the disk's mechanical properties to the media certifier and configuring the media certifier to enable simultaneous access to the disk by the product head and the certifier head.

25. A method of certifying a disk based on degree of micro-waviness of the disk or flying height modulation, the disk having a track pattern written by a certifier head, the method comprising
a product head, reading the track pattern to obtain a first read-back signal; and
comparing the first read-back signal and a second read-back signal, the second read-back signal being a signal obtained by the certifier head reading the track pattern, to determine the degree of micro-waviness of the disk or flying height modulation for certifying the disk.

26. A method according to claim 25, further comprising calculating a difference from the comparison and comparing the difference with a threshold to certify the disk.

27. A method according to claim 25 or 26, further comprising configuring the certifier head and the product head to access the disk simultaneously.

28. Apparatus for certifying a disk based on degree of micro-waviness of the disk or flying height modulation, the disk having a track pattern written by a certifier head, the apparatus comprising
a product head configured to read the track pattern to obtain a first read-back signal; and
a processor configured to compare the first read-back signal and a second read-back signal, the second read-back signal being a signal obtained by the certifier head reading the track pattern, to determine the degree of micro-waviness of the disk or flying height modulation for certifying the disk.

29. A method of certifying a disk having a track pattern written by a certifier head, the method comprising
a product head, reading the track pattern to measure the disk's mechanical properties; and
isolating magnetic induced information from the product head's measurement based on the certifier head's measurement of the disk's magnetic properties.

30. A method according to claim 29, wherein the measurement of the disk's magnetic properties include missing pulse or readback envelope amplitude measurement and the measurement of the disk's mechanical properties include in-situ flying height measurement, and the method further comprises normalising intensities of the missing pulse or readback envelope amplitude and the flying height measurements and subtracting one of the measurements from the other to isolate the magnetic induced information.

31. A method according to claim 29 or 30, further comprising configuring the certifier head and the product head to access the disk simultaneously.

32. Apparatus for certifying a disk having a track pattern written by a certifier head, the apparatus comprising:
a product head configured to read the track pattern to measure the disk's mechanical properties; and
a processor for isolating magnetic induced information from the product head's measurement based on the certifier head's measurement of the disk's magnetic properties.
